(19) United States
(12) Patent Application Publication
(10) Pub. No.: US 2005/0042960 A1
(43) Pub. Date: Feb. 24, 2005

(54) Electromagnetic radiation shielding fabric

(75) Inventors: Ya-Hui Yeh, Ping-Tung Hsien (TW); Cheng-Tao Wu, Kaohsiung City (TW); Lee-Cheng Chen, Tainan City (TW)

Correspondence Address: WEBB ZIESENHEIM LOGSDON ORKIN & HANSON, P.C., 700 Koppers Building, 436 Seveth Avenue, Pittsburgh, PA, 15219-1818, US

(73) Assignee: HELIX TECHNOLOGY, INC.

(21) Appl. No.: 10/792,422

(22) Filed: Mar. 3, 2004

(30) Foreign Application Priority Data
Aug. 18, 2003 (TW) 092214907

(51) Int. Cl. B32B 15/14; B32B 15/20

(52) U.S. Cl. 442/131; 442/64; 442/65

(57) ABSTRACT

An electromagnetic radiation shielding fabric includes a fabric substrate, a first interfacial layer formed on the fabric substrate, and at least a radiation shielding unit formed on the first interfacial layer and including two shielding layers, each of which is made from a first metal, and a second interfacial layer interposed between the shielding layers and made from a second metal. The first metal is selected from the group consisting of copper, silver, gold, and aluminum. The second metal is selected from the group consisting of nickel, chromium, nickel-chromium alloy, and titanium.

### CROSS-REFERENCE TO RELATED APPLICATION

This application claims priority of Taiwanese application No. 092214907, filed on Aug. 18, 2003.

### BACKGROUND OF THE INVENTION

1. Field of the Invention

This invention relates to an electromagnetic radiation shielding fabric, more particularly to an electromagnetic radiation shielding fabric having a fabric substrate and at least a radiation shielding unit formed on the fabric substrate and having two shielding layers and an interfacial layer interposed between the shielding layers.

2. Description of the Related Art

FIG. 1 illustrates a conventional electromagnetic radiation shielding fabric that includes a fabric substrate 21 with two opposite side faces, two interfacial layers 22 formed respectively on the side faces of the fabric substrate 21, two shielding layers 23 formed respectively on the interfacial layers 22, and two protective layers 24 formed respectively on the shielding layers 23. Each of the shielding layers 23 is made from a metal, such as copper, aluminum, silver, and gold, that has high level shielding capability, which is proportional to the electrical conductivity thereof. It is noted that the metal for forming the shielding layers 23 has poor coating capability on the fabric substrate 21. As a consequence, the interfacial layers 22 are made from a metal having much higher adhesion to the fabric substrate 21 than that of the shielding layers 23 so as to serve as an adhering medium for adherence of the shielding layers 23 to the fabric substrate 21. The protective layers 24 are made from a metal resistant to oxidation so as to prevent the shielding layers 23 from being oxidized.

The aforesaid conventional electromagnetic radiation shielding fabric is disadvantageous in that the shielding layers 23 tend to break due to internal stress or deformation during handling and that the metal, particularly copper and aluminum, for forming the shielding layers 23 tends to oxidize when protection of the protective layer 24 degrades after a period of use. As a consequence, the shielding effect of the conventional electromagnetic radiation shielding fabric degrades significantly after a period of use.

### SUMMARY OF THE INVENTION

Therefore, the object of the present invention is to provide an electromagnetic radiation shielding fabric that is capable of overcoming the aforesaid drawbacks of the prior art.

According to the present invention, there is provided an electromagnetic radiation shielding fabric that includes: a fabric substrate; a first interfacial layer formed on the fabric substrate; and at least a radiation shielding unit formed on the first interfacial layer and including two shielding layers, each of which is made from a first metal, and a second interfacial layer interposed between the shielding layers and made from a second metal. The first metal is selected from the group consisting of copper, silver, gold, and aluminum. The second metal is selected from the group consisting of nickel, chromium, nickel-chromium alloy, and titanium.

### BRIEF DESCRIPTION OF THE DRAWINGS

In drawings which illustrate an embodiment of the invention,

FIG. 1 is a fragmentary sectional view of a conventional electromagnetic radiation shielding fabric; and

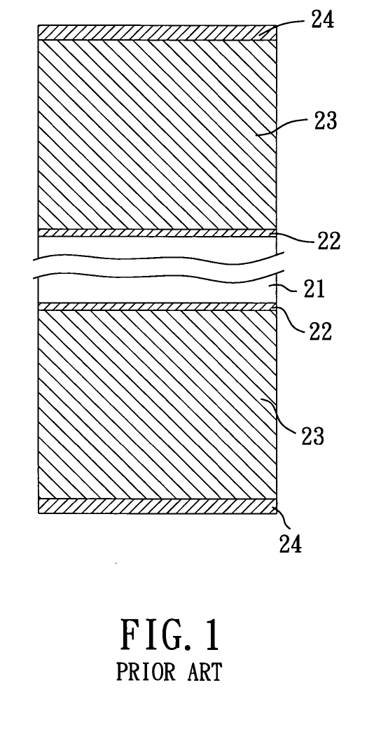

FIG. 2 is a fragmentary sectional view of the preferred embodiment of an electromagnetic radiation shielding fabric according to the present invention.

### DETAILED DESCRIPTION OF THE PREFERRED EMBODIMENT

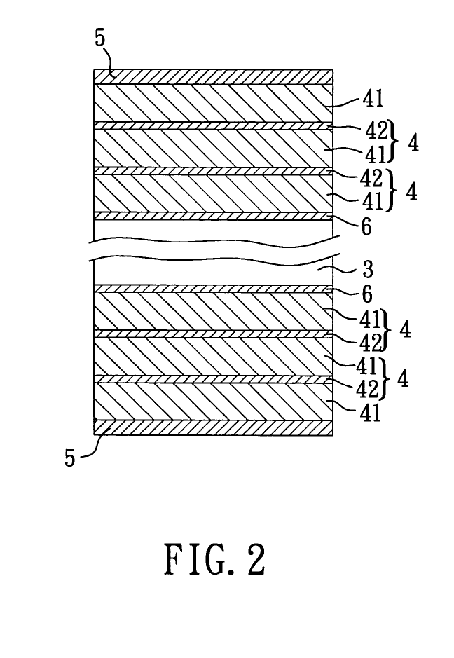

FIG. 2 illustrates the preferred embodiment of an electromagnetic radiation shielding fabric according to the present invention.

The electromagnetic radiation shielding fabric includes: a fabric substrate 3 with two opposite side faces; two first interfacial layers 6 formed respectively on the side faces of the fabric substrate 3; at least two shielding layers 41, which are made from a first metal, stacked one above the other and formed on the first interfacial layer 6 on each side face of the fabric substrate 3, the first interfacial layers 6 being made from a metal that has better adherence to the fabric substrate 3 than the first metal so as to permit adhesion of the shielding layers 41 to the fabric substrate 3; and at least a second interfacial layer 42 interposed between the shielding layers 41 and made from a second metal which differs from the first metal and which stabilizes the shielding layers 41 against breaking and oxidation. In this embodiment, three of the shielding layers 41 and two of the second interfacial layers 42 on each side face of the fabric substrate 3 are used for forming the electromagnetic radiation shielding fabric of this invention. Each second interfacial layer 42 and two adjacent shielding layers 41 form a radiation shielding unit 4 on the fabric substrate 3. With the inclusion of the second interfacial layer 42 in the electromagnetic radiation shielding fabric of this invention, degradation of the shielding effect provided by the shielding layers 41 can be considerably slowed down. The larger the number of the radiation shielding units 4, the lower will be the degradation rate of the shielding effect of the electromagnetic radiation shielding fabric of this invention.

A protective layer 5 is formed on the outermost one of the shielding layers 41 on the first interfacial layer 6 on each side face of the fabric substrate 3, and is preferably made from a metal resistant to oxidation so as to prevent the shielding layers 41 from being oxidized.

Preferably, the first metal has a high level electrical conductivity, and is selected from the group consisting of copper, silver, gold, and aluminum. More preferably, the first metal is copper.

Preferably, the second metal is selected from the group consisting of nickel, chromium, nickel-chromium alloy, and titanium. The first interfacial layer 6 and the protective layer 5 on each side face of the fabric substrate 3 are preferably made from the second metal.

The fabric substrate 3 can be a woven (knitted or shuttled) or non-woven fabric. Preferably, the fabric substrate 3 is made from a plurality of synthetic fiber yarns having high tensile strength, high resistance to wearing, and high elastic modulus.

The present invention will now be described in greater detail with reference to the following Comparative Examples 1 to 3 and Illustrative Examples 1 to 3.

The electromagnetic radiation shielding fabric of each Comparative Example has a structure that includes a fabric substrate, two interfacial layers formed respectively on two opposite side faces of the fabric substrate, and two protective layers formed respectively on the interfacial layers. The electromagnetic radiation shielding fabric of each Illustrative Example has a structure that includes a fabric substrate, two first interfacial layers formed on two opposite side faces of the fabric substrate, three shielding layers formed on each first interfacial layer, a second interfacial layer interposed between each adjacent pair of the shielding layers, and a protective layer formed on the outermost one of the shielding layers on each side face of the fabric substrate. Formation of the interfacial layers or the first and second interfacial layers, the shielding layers, and the protective layers of the Comparative Examples and the Illustrative Examples were conducted through sputtering vapor deposition. The sputtering process was conducted under the following conditions:
(1) sputtering power: ranging from 200-600 W and preferably at about 400 W for the interfacial layers or the first and second interfacial layers; ranging from 300-1000 W and preferably at about 500 W for the shielding layers; and ranging from 300-1000 W and preferably at about 800 W for the protective layers (note that the fabric substrate can be damaged or shrink when the sputtering power is too high, and that the sputtering rate can be too slow when the sputtering power is too low);
(2) sputter chamber pressure: ranging from 3.0-5.5×10⁻³ torr, preferably ranging from 3.8-4.1×10⁻³ torr;
(3) fabric moving speed: ranging from 2-15 mm/sec and preferably at 5 mm/sec (the fabric substrate tends to be damaged or shrink when the moving speed is too slow, while the sputtering rate can be too slow when the moving speed is too fast) and
(4) sputtering time: ranging from 10-88 seconds and preferably at 35.2 seconds for the shielding layers, and ranging from 5-44 seconds and preferably at 17.6 seconds for the interfacial layers or the first and second interfacial layers and the protective layers.

Table 1 shows the materials used for the fabric substrate, the interfacial layers, the shielding layers, and the protective layers, and the thicknesses of the interfacial layers, the shielding layers, and the protective layers of the Comparative Examples 1-3.

TABLE 1

| | | Comparative Example | | |
|---|---|---|---|---|
| | | 1 | 2 | 3 |
| Fabric substrate | material | Non-woven, | Non-woven, | Shuttled, |
| | | PET | PET | PET |
| | Density | 90 g/m³ | 30 g/m³ | 200 mesh |
| Interfacial layer | material | Cr | Ti | Ti |
| | Thickness, Å | 180 | 160 | 160 |
| Shielding layer | material | Cu | Cu | Cu |
| | Thickness, Å | 4570 | 4570 | 4570 |
| Protective layer | material | Cr | Ti | Ti |
| | Thickness, Å | 360 | 650 | 650 |

Table 2 shows the materials used for the fabric substrate, the first and second interfacial layers, the shielding layers, and the protective layers, and the thicknesses of the first and second interfacial layers, the shielding layers, and the protective layers of the Illustrative Examples 1-3.

TABLE 2

| | | Illustrative Example | | |
|---|---|---|---|---|
| | | 1 | 2 | 3 |
| Fabric substrate | material | Non-woven, | Non-woven, | Shuttled, |
| | | PET | PET | PET |
| | Density | 90 g/m³ | 30 g/m³ | 200 mesh |
| First interfacial | Material | Cr | Ti | Ti |
| layer | Thickness, Å | 180 | 160 | 160 |
| second | Material | Cr | Ti | Ti |
| interfacial layer | Thickness, Å | 180 | 160 | 160 |
| Shielding layer | material | Cu | Cu | Cu |
| | Thickness, Å | 910 | 910 | 910 |
| Protective layer | material | Cr | Ti | Ti |
| | Thickness, Å | 360 | 650 | 650 |

The samples of the Comparative Examples and Illustrative Examples were measured in shielding effectiveness (the level of db) using different power frequency before and after a three-month weathering test. Tables 3 and 4 show the measured initial shielding effectiveness (initial db) and shielding effectiveness (weathered db) after the three-month the weathering test and the degradation of the shielding effectiveness for the Comparative Examples and the Illustrative Examples, respectively.

TABLE 3

| | Comparative Example | | | | | | | | |
|---|---|---|---|---|---|---|---|---|---|
| power | 1 | | | 2 | | | 3 | | |
| frequency | Initial | Weathered | Degradation, | Initial | Weathered | Degradation, | Initial | Weathered | Degradation |
| MHz | do | do | % | do | do | % | do | do | % |
| 30 | 37.12 | 34.30 | −7.60 | 46.84 | 45.19 | −3.52 | 34.60 | 25.57 | −26.1 |
| 101 | 37.76 | 34.24 | −9.32 | 47.48 | 45.65 | −3.85 | 34.38 | 21.36 | −37.87 |
| 499 | 38.84 | 35.09 | −9.65 | 48.47 | 45.84 | −5.43 | 48.73 | 41.42 | −15.00 |
| 900 | 38.63 | 34.91 | −9.63 | 48.77 | 45.00 | −7.73 | 45.98 | 43.27 | −5.89 |
| 1200 | 40.20 | 36.73 | −8.63 | 49.59 | 45.22 | −8.81 | 46.05 | 44.70 | −2.93 |
| 1500 | 40.48 | 36.2 | −10.57 | 50.84 | 45.28 | −10.94 | 47.54 | 45.65 | −3.98 |
| 2451 | 42.57 | 39.56 | −7.07 | 52.27 | 39.40 | −13.91 | 47.72 | 47.72 | −0.52 |
| 3000 | 42.92 | 40.00 | −6.80 | 51.80 | 46.06 | −16.60 | 46.91 | 46.91 | 1.30 |

TABLE 4

| | Illustrative Example | | | | | | | | |
|---|---|---|---|---|---|---|---|---|---|
| power | 1 | | | 2 | | | 3 | | |
| frequency | Initial | Weathered | Degradation, | Initial | Weathered | Degradation, | Initial | Weathered | Degradation |
| MHz | do | do | % | do | do | % | do | do | % |
| 30 | 36.40 | 36.65 | 0.69 | 46.50 | 47.70 | 2.58 | 26.02 | 26.18 | 0.61 |
| 101 | 36.81 | 37.22 | 1.22 | 47.06 | 48.32 | 2.68 | 26.88 | 29.34 | 9.15 |
| 499 | 36.90 | 37.90 | 2.71 | 47.29 | 48.70 | 2.98 | 39.10 | 40.72 | 4.14 |
| 900 | 36.78 | 37.10 | 0.87 | 46.90 | 48.03 | 2.41 | 41.68 | 42.63 | 2.28 |
| 1200 | 36.82 | 38.42 | 4.35 | 46.91 | 48.36 | 3.09 | 43.24 | 44.26 | 2.36 |
| 1500 | 37.65 | 37.30 | −0.93 | 47.88 | 48.36 | 1.00 | 45.05 | 45.31 | 0.58 |
| 2451 | 38.67 | 39.20 | 1.37 | 46.85 | 48.40 | 3.31 | 49.02 | 47.84 | −2.41 |
| 3000 | 37.89 | 39.66 | 4.67 | 44.97 | 46.30 | 2.96 | 48.77 | 47.79 | −2.01 |

The test results show that significant degradation in the shielding effectiveness is likely to take place after a period of use for the Comparative Examples, whereas the shielding effectiveness remains almost unchanged for the Illustrative

### EXAMPLES

With the inclusion of the second interfacial layer 42 in the electromagnetic radiation shielding fabric of this invention, the aforesaid drawbacks associated with the prior art can be eliminated.

With the invention thus explained, it is apparent that various modifications and variations can be made without departing from the spirit of the present invention.

1. An electromagnetic radiation shielding fabric comprising:
a fabric substrate;
a first interfacial layer formed on said fabric substrate; and
at least a radiation shielding unit formed on said first interfacial layer and including two shielding layers, each of which is made from a first metal, and a second interfacial layer interposed between said shielding layers and made from a second metal;
wherein said first metal is selected from the group consisting of copper, silver, gold, and aluminum, and said second metal is selected from the group consisting of nickel, chromium, nickel-chromium alloy, and titanium.

2. The electromagnetic radiation shielding fabric of claim 1, wherein said first metal is copper.

3. The electromagnetic radiation shielding fabric of claim 1, further comprising a protective layer formed on said radiation shielding unit, said protective layer being made from said second metal.

4. The electromagnetic radiation shielding fabric of claim 1, wherein said first interfacial layer is made from said second metal.

5. The electromagnetic radiation shielding fabric of claim 1, wherein said fabric substrate is a shuttled fabric and is made from synthetic fibers.

6. An electromagnetic radiation shielding fabric comprising:
a fabric substrate having two opposite side faces;
two first interfacial layers formed respectively on said side faces of said fabric substrate; and
two radiation shielding units formed respectively on said first interfacial layers, each of said radiation shielding units including two shielding layers, each of which is made from a first metal, and a second interfacial layer interposed between said shielding layers and made from a second metal;
wherein said first metal is selected from the group consisting of copper, silver, gold, and aluminum, and said second metal is selected from the group consisting of nickel, chromium, nickel-chromium alloy, and titanium.

7. The electromagnetic radiation shielding fabric of claim 6, wherein said first metal is copper.

8. The electromagnetic radiation shielding fabric of claim 6, wherein each of said shielding layers has a thickness less than 1500 Å, said second interfacial layer having a thickness less than 200 Å.

9. The electromagnetic radiation shielding fabric of claim 6, further comprising two protective layers formed respectively on said radiation shielding units, each of said protective layers being made from said second metal.

10. The electromagnetic radiation shielding fabric of claim 6, wherein each of said first interfacial layers is made from said second metal.

11. The electromagnetic radiation shielding fabric of claim 6, wherein said fabric substrate is a shuttled fabric and is made from synthetic fibers.

12. An electromagnetic radiation shielding fabric comprising:
a fabric substrate;
a first interfacial layer formed on said fabric substrate; and
at least a radiation shielding unit formed on said first interfacial layer and including two shielding layers, each of which is made from a first metal, and a second interfacial layer interposed between said shielding layers and made from a second metal which differs from said first metal and which stabilizes said shielding layers against breaking and oxidation.

13. The electromagnetic radiation shielding fabric of claim 12, wherein said first metal is selected from the group consisting of copper, silver, gold, and aluminum, and said second metal is selected from the group consisting of nickel, chromium, nickel-chromium alloy, and titanium.

14. The electromagnetic radiation shielding fabric of claim 13, wherein said first metal is copper.
